(19) United States
(12) Patent Application Publication
(10) Pub. No.: US 2020/0201700 A1
(43) Pub. Date: Jun. 25, 2020

(54) DEVICE, SYSTEM AND METHOD TO IDENTIFY A SOURCE OF DATA POISONING

(71) Applicant: Intel Corporation, Santa Clara, CA (US)

(72) Inventors: Mohan J. Kumar, Aloha, OR (US); Theodros Yigzaw, Sherwood, OR (US); Murugasamy Nachimuthu, Beaverton, OR (US); Ashok Raj, Portland, OR (US); Jose Vargas, Rescue, CA (US)

(73) Assignee: Intel Corporation, Santa Clara, CA (US)

(21) Appl. No.: 16/228,554

(22) Filed: Dec. 20, 2018

(51) Int. Cl. G06F 11/07

(52) U.S. Cl. CPC G06F 11/079; G06F 11/0751; G06F 11/073

(57) ABSTRACT

Techniques and mechanisms for a processor to efficiently identify a circuit resource as being a source of data poisoning. In an embodiment, metadata is communicated, in association with a communication of poisoned data to which the metadata pertains, to a first circuit block of a processor. The metadata indicates a poisoned state of the data, wherein the metadata identifies a second circuit block—which is included in or coupled to the processor—as being a poisoner of the data. Based on the metadata, the first circuit block generates a fault message which identifies the second circuit block as the poisoner of the data. In another embodiment, the processor further comprises the second circuit block, which poisons the data (based on the detection of an error condition) by providing in the metadata a unique identifier which is assigned to the second circuit block.

### BACKGROUND

### 1. Technical Field

Embodiments of the invention relate generally to processor operations and more particularly, but not exclusively, to the communication of metadata describing poisoned data.

### 2. Background Art

Despite the presence of error-control coding (ECC) in computer systems, it is still possible for uncorrectable errors to occur. For example, in many systems a two-bit ECC (2×ecc) error may not be correctable. If data containing such errors is consumed by a processor, it can cause spurious computational results, or it can even cause an operating system (OS) to go down, e.g., by means of a machine check abort (MCA). As a result, the availability and reliability of such a computer system are reduced.

One recent refinement is to detect uncorrectable data errors and to mark the data containing such errors. This technique is known as “data poisoning.” Typically, data is tagged with a “poison” bit and forwarded to some destination, where a non-fatal error is sent, with information about the poisoning event, to another destination for recording as an entry in a separate log.

A judgement about the error is thus suspended, essentially, until some time and place of later consumption of the poisoned data. If, for example, a point of later data consumption is a graphics card, an uncorrected data error (as indicated by the poison bit) can be ignored as having negligible system impact. If on the other hand, poisoned data is to be used by a processor core running a workload, then the core will typically forego consuming the corrupted data, and allow system software to recover from the error condition, where a fatal error is likely to occur, if software cannot resolve the error.

One limitation of such conventional data poisoning techniques is they allow for significant temporal and/or physical distance between a time and place of a data poisoning and a time and place of potential consumption of the poisoned data. Additional complications are posed by speculative accesses, prefetches, and cache evictions. Hence, information about the source of a data poisoning is not available at the point of later data consumption, and retrieval of such information (in order to prevent a system shut-down) often tends to be slow or impossible.

### BRIEF DESCRIPTION OF THE DRAWINGS

The various embodiments of the present invention are illustrated by way of example, and not by way of limitation, in the figures of the accompanying drawings and in which:

FIG. 1 is a functional block diagram illustrating elements of a system to communicate information which identifies a source of data poisoning according to an embodiment.

FIG. 2 is a flow diagram illustrating elements of a method to communicate data poisoning information according to an embodiment.

FIG. 3 is a functional block diagram illustrating elements of a circuit to participate in a communication of data poisoning information according to an embodiment.

FIGS. 4 and 5 are swim lane diagrams each illustrating elements of a respective sequence, according to a corresponding embodiment, to determine a source of data poisoning.

FIG. 6 is a data format diagram illustrating an error log which is registered based on data poisoning information according to an embodiment.

FIG. 7A is a block diagram illustrating both an exemplary in-order pipeline and an exemplary register renaming, out-of-order issue/execution pipeline according to embodiments of the invention.

FIG. 7B is a block diagram illustrating both an exemplary embodiment of an in-order architecture core and an exemplary register renaming, out-of-order issue/execution architecture core to be included in a processor according to embodiments of the invention.

FIG. 8 is a block diagram of a processor that may have more than one core, may have an integrated memory controller, and may have integrated graphics according to embodiments of the invention.

FIGS. 9 through 11 are block diagrams of exemplary computer architectures.

### DETAILED DESCRIPTION

Embodiments discussed herein variously provide techniques and mechanisms for a processor to efficiently identify a circuit resource as being a source of data poisoning. In an embodiment, metadata is communicated, in association with a communication of poisoned data to which the metadata pertains, to a resource of a processor, where the metadata identifies some circuit block as being a poisoner of the data. In communicating such metadata along with corresponding poisoned data, some embodiments variously facilitate efficient identification of a poisoner.

As used herein, “poisoned,” and “poisoned state” variously refer to a classification (or state of being classified) for data which has been determined to be at least potentially corrupt, out-of-date, indeterminate, or otherwise defective. The term “poisoning” refers generally to a generating, updating or other accessing of metadata corresponding to some data, where—as a result of such accessing—the metadata includes a value which specifies or otherwise indicates that the data is poisoned. In some embodiments, data poisoning further results in the metadata identifying a poisoner of the data, where “poisoner”—in this particular context—refers herein some resource (e.g., a circuit block) which has made a made a determination that the data is to be poisoned.

Communication of data is understood to be “in association with” (as referred to herein) communication of corresponding metadata where, for example, the data and metadata are both communicated, from the same “source” circuit block to the same “sink” circuit block, based on the same access request (or other such cause). In some embodiments, such data and metadata are included in the same communication—e.g., for loading to the same register or for storing to the same memory block. In other embodiments, such data and metadata are included in different respective communications—e.g., at different times and/or via different paths—which, nevertheless, are in response to the same data access request.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

It is pointed out that those elements of the figures having the same reference numbers (or names) as the elements of any other figure can operate or function in any manner similar to that described, but are not limited to such.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which is operable communicate information which describes poisoned data.

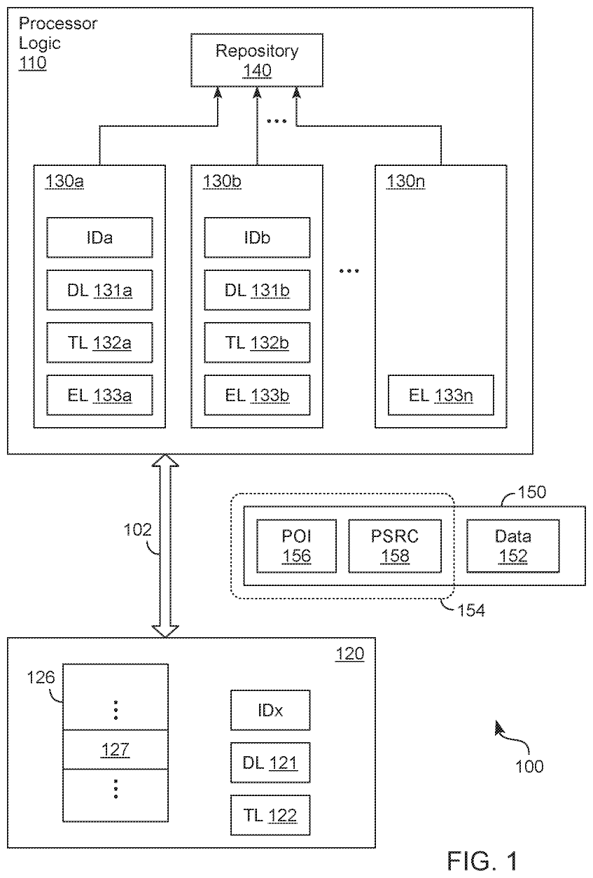

FIG. 1 shows features of a system 100, according to an embodiment, to determine whether a memory resource has been initialized. System 100 is one example of an embodiment wherein circuitry of a processor is operable to access and evaluate metadata which identifies a poisoner of some poisoned data that (for example) is indicated by an instruction of a software application. In various embodiments, such circuitry participates in a communication of the data in association with communication of the metadata—e.g., wherein the metadata is provided independent of a need for the circuitry to reference a table or other repository (if any) which might provide some log or other listing of events which include data poisoning events.

As shown in FIG. 1, system 100 includes processor logic 110 comprising various circuit blocks (such as the illustrative circuit blocks 130a, 130b, . . . , 130n shown) each to provide a respective data processing functionality. For example, circuit blocks 130a, 130b, . . . , 130n each perform a respective one of branch prediction, data storage, data caching, instruction caching, instruction decoding, scheduling, instruction execution, memory accessing/interface, instruction queueing/de-queueing, signal input and/or output (e.g., Tx/Rx), or any of various other processor functions. In various embodiments, processor logic 110 comprises more, fewer or differently arranged circuit blocks, and some embodiments are not limited to the functionality that is provided by any particular one of circuit blocks 130a, 130b, . . . , 130n.

In an embodiment, system 100 further comprises a memory 120 coupled to processor logic 110 via an interconnect 102. Processor logic 110 includes some access logic (comprising a memory management unit at one of circuit blocks 130a, 130b, . . . , 130n, for example) to perform and/or control access to memory 120. In some embodiments, memory 120 is a memory (e.g., system memory) which is local to a hardware processor that comprises processor logic 110. Alternatively, memory 120 may be a memory which is distinct from the hardware processor—e.g., where memory 120 and the processor are at different regions of an IC chip, on different IC chips, in different packages, or the like. Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein.

During operation of system 100, a first circuit block of processor logic 110 (or alternatively, a first circuit block coupled to processor logic 110) is able to detect an error condition which is indicative of some data being at least potentially corrupt, out-of-date, or otherwise defective—e.g., wherein a defective state of the data is (actually or potentially) a cause of, caused by, or otherwise associated with, the occurrence of the error event. For example, the first circuit block, in some embodiments, detects that the error event is one instance of an event type which is predefined as being associated with defective data. Based on the detection of such an error condition, the first circuit block determines that some associated data is to be poisoned. The recognition of an error event as being a basis for data poisoning, and the identification of particular data to be so poisoned, includes operations which, for example, are adapted from conventional data poisoning techniques. Such conventional techniques are not limiting on some embodiments, and are not detailed herein to avoid obscuring certain features of various embodiments.

Poisoning of data by the first circuit block includes the first circuit block accessing metadata (directly or indirectly) which corresponds to said data, where such accessing is to indicate with said metadata a poisoned state of the data. In various embodiments, the poisoning results in the metadata identifying the first circuit block as the poisoner of the data. In such an embodiment, various circuit blocks of system 100—including one or more circuit blocks of processor logic 110—operate to support communication of such data and corresponding metadata in association with each other. For example, a communication of the data to one of the circuit blocks 130a, 130b, . . . , 130n—from another circuit block of system 100—includes, or otherwise has the same cause as, a concurrent or otherwise associated communication of the corresponding metadata to that same one of the circuit blocks 130a, 130b, . . . , 130n.

The communication of metadata and corresponding data in association with each other—where the metadata identifies a poisoner of the corresponding data—enables a given circuit block of processor logic 110 to efficiently identify the poisoner of the data. For example, various embodiments avoid the need for such a circuit block to begin additional communications, in response to a detection of some data's poisoned state, to determine the identity of a poisoner from some external log (or other data structure) which describes data poisoning events. Moreover, some embodiments eliminate or otherwise mitigate the need for, and/or utilization of, any such external log or other data structure.

To facilitate efficient identification of a data poisoner according to some embodiments, one or more circuit blocks of processor logic 110 each include respective circuitry to detect some error condition which is to be a basis for data poisoning. For example, circuit block 130a and circuit block 130b include respective detector logic (DL) 131a, 131b, each to detect for any of a respective one or more error conditions—e.g., where memory 120 also includes similar detector logic DL 121.

Such one or more circuit blocks of processor logic 110 further include respective circuitry to variously perform data poisoning based on the detection of error conditions. For example, circuit block 130a includes tagger logic (TL) 132a which, responsive to an error condition being detected by DL 131a, poisons some data by associating—or “tagging”—the data with metadata which indicates a poisoned state of said data. Similarly, tagger logic TL 132b of circuit block 130b is operable to poison data in response to an error condition being detected by DL 131b—e.g., where tagger logic TL 122 of memory 120 similarly supports data poisoning in response to an error condition being detected by DL 121.

In some embodiments, poisoning of data by tagger logic (e.g., by one of TL 132a, TL 132b, TL 122) includes the tagger logic providing metadata which includes an identifier of the circuit block which generated the decision to poison said data. By way of illustration and not limitation, various circuit blocks of system 100 are each assigned or otherwise associated with a different respective identifier—e.g., where circuit blocks 130a, 130b and memory 120 correspond to unique identifiers IDa, IDb, IDx (respectively). Some or all such unique identifiers are assigned, for example, by a Basic Input/Output System (BIOS) during a system, boot-up, by hardware circuit straps, and/or any of various other mechanisms (which are not limiting on some embodiments).

The unique identifiers (e.g., including IDa, IDb, and IDx), after being assigned by or otherwise determined at the BIOS, are provided, for example, to an agent of system 100—e.g., an operating system (OS), a management subsystem or the like—which facilitates the determining of functional blocks each based on a corresponding one of said unique identifiers. Such an agent operates to resolve an association of a given unique identifier with a particular field-replaceable unit (FRU), a particular IC chip, a particular circuit block of an IC chip, or the like. In different embodiments, system management BIOS (SMBIOS) FRU handles, Advanced Configuration and Power Interface tables, or any of various resource management application program interfaces (APIs) are adapted, for example, to implement or otherwise support such resolving by said agent.

In such an embodiment, data poisoning by circuit block 130a comprises TL 132a tagging data with metadata which includes or otherwise communicates the identifier IDa. Similarly, data poisoning by circuit block 130b comprises (for example) TL 132b tagging data with metadata which is to communicate the identifier IDb—e.g., where data poisoning by memory 120 comprises TL 122 tagging data with metadata which is to communicate the identifier IDx.

In various embodiments, one or more circuit blocks of processor logic 110 additionally or alternatively include respective circuitry to receive metadata and to efficiently identify—based on the said metadata—a poisoner (if any) of data which is communicated in association with the received metadata. For example, circuit block 130a includes evaluation logic (EL) 133a which is operable to evaluate, based on metadata received from some other circuit block (e.g., from one of circuit blocks 132b, . . . , 132n or from memory 120), whether some corresponding data is poisoned. In such an embodiment, circuit blocks 130b, 130n (for example) include—respectively—evaluator logic EL 133b and evaluator logic EL 133 each to similarly detect for a poisoned state of some received data. Evaluating metadata with evaluator logic (e.g., with one of EL 133a, EL 133b, EL 133n) includes the evaluator logic accessing an identifier of a circuit block as a poisoner of data which corresponds to the metadata.

In some embodiments, at least one circuit block of system 100 provides data poisoning functionality as described herein, and at least some other circuit block (of processor logic 110) provides metadata evaluation functionality to evaluate metadata which is accessed by such data poisoning functionality. One or more circuit blocks, in some embodiments, each include respective one—and only one—of such data poisoning functionality and metadata evaluation functionality. By way of illustration and not limitation, in one embodiment, circuit block 130n omits some data poisoning functionality, and memory 120 omits some metadata evaluation functionality.

In an illustrative scenario according to one embodiment, a circuit block of processor logic 110 (in this example, circuit block 130a) receives previously-poisoned data—e.g., where memory 120, for example, communicates to circuit block 130a data which has been poisoned by memory 120 or, alternatively, by some other circuit block which then communicated said poisoned data to memory 120.

In one such embodiment, DL 121 of memory 120 detects an error condition which is indicative of some data being at least potentially defective. Based on the detection of such an error condition, DL 121 determines that some associated data (e.g., at an addressable memory block 127 of a memory array 126) is to be poisoned. Poisoning of such data by memory 120 includes TL 122 accessing metadata which corresponds to said data. Such accessing results in the metadata indicating a poisoned state of the data, wherein the metadata includes or is to otherwise communicate, based on identifier IDx, that memory 120 is the poisoner of the data. The metadata is stored, for example, in reserve bits (e.g., upper bits) of memory block 127 or, in another embodiment, in a portion of array 126 which reserved for use as a table or other repository of such metadata. Some embodiments are not limited to a particular location or format whereby memory 120 provides such metadata.

In response to a memory access request, memory 120 communicates the previously-poisoned data at memory block 127 to circuit block 130a (for example)—e.g., where memory 120 also communicates the corresponding metadata in association with such communication of the poisoned data. In the illustrative embodiment shown, a communication 150 via interconnect 102 from memory 120 to processor logic 110 includes data 152 (in this example, the poisoned data at memory block 127), and metadata 154 corresponding thereto. The metadata 154 includes a poison source identifier PSRC 158, comprising or otherwise based on identifier IDx, which identifies memory 120 as the poisoner of data 152. In some embodiments, metadata 154 further comprises a poison state identifier POI 156 comprising one or more bits, the value of which specifies that data 152 is poisoned. In another embodiment, metadata 154 omits POI 156—e.g., where the value of PSRC 158 serves as both an indication that data 152 is poisoned, and as an implicit indication of such data poisoning. In still another embodiment, data 152 and some or all of metadata 154 are provided to circuit block 130a in different respective communications which, for example, are each in reply to the same data access request.

Based on the communication of IDx with poison source identifier PSRC 158, EL 133a detects that memory 120 is the poisoner of data 152. In response to detecting the poisoned state of data 152, EL 133a (or other suitable circuitry of circuit block 130a) generates a fault message which is provided, for example, to a repository 140 comprising one or more registers to store information about the fault. Repository 140 may function as a log or other resource to track fault events which are related to data poisoning—e.g., where repository 140 is to receive fault information which identifies various circuit blocks each as a poisoners of respective data.

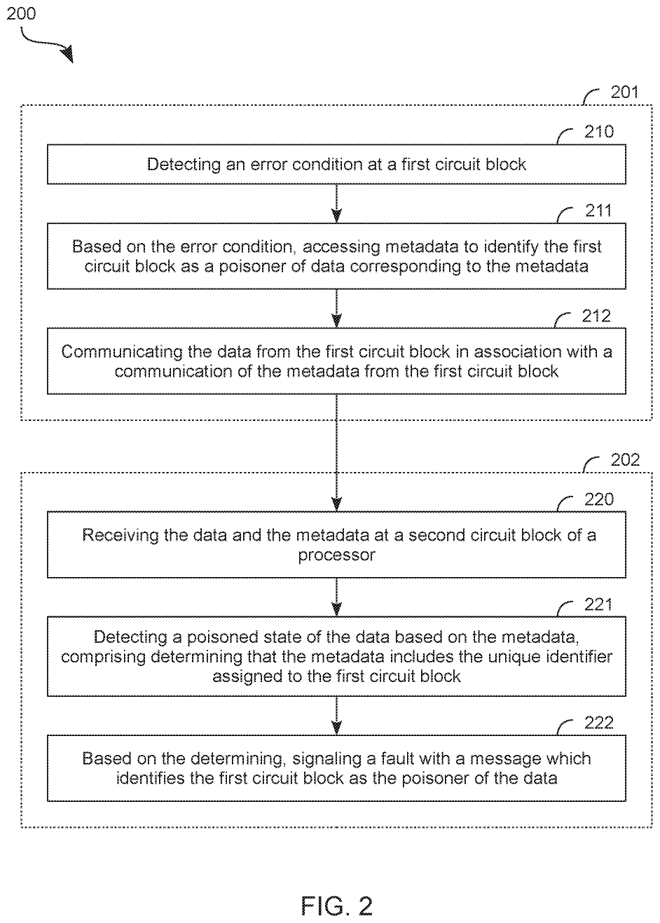

FIG. 2 shows features of a method 200, performed with a processor, to communicate data poisoning information according to an embodiment. Method 200 is one example of an embodiment wherein metadata is communicated in association with the communication of corresponding data, wherein the metadata indicates a poisoned state of said data, the metadata specifying a circuit resource as being a poisoner of the data. Method 200 is performed with processor circuitry which provides some or all of the functionality of system 100, for example.

As shown in FIG. 2, method 200 includes operations 201 performed at a first circuit block which, for example, is a component of (or alternatively, distinct from, and coupled to) a processor which performs at least some of method 200. In an embodiment, operations 201 comprise (at 210) detecting an error condition at a first circuit block and, based on the detecting at 210, accessing metadata (at 211) to identify the first circuit block as a poisoner of data which corresponds to the metadata. For example, in some embodiments a format of the metadata comprises a poison source field which is to store an identifier of a data poisoner—e.g., wherein a storage of a default value at the poison source field indicates a non-poisoned state of the data in question. In some embodiments, the format further comprises a distinct poison state flag field including one or more bits, the value of which is to specify whether (or not) the data in question is poisoned. Operations 201 further comprise (at 212) communicating the data, from the first circuit block, in association with a communication, from the first circuit block, of the metadata accessed at 211.

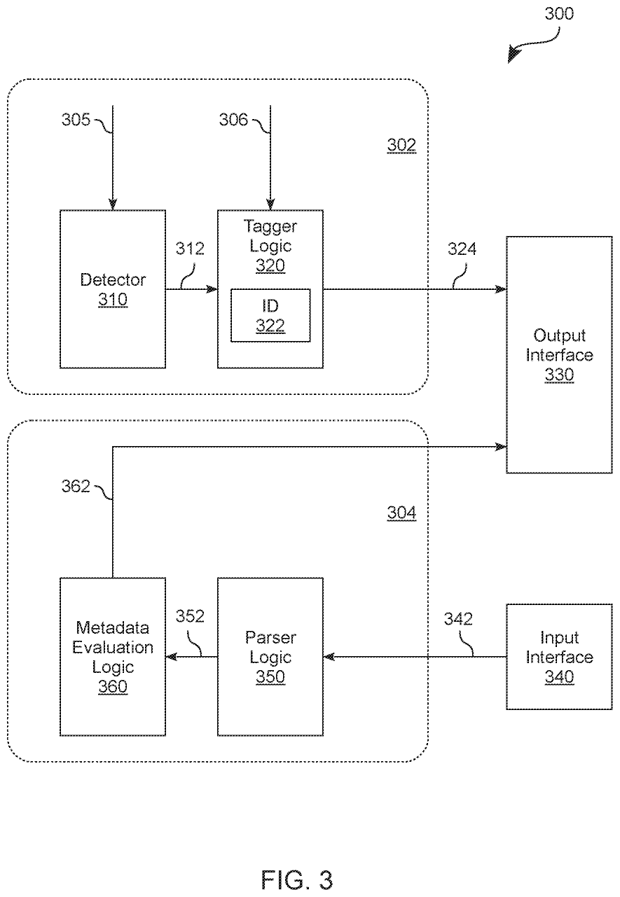

By way of illustration and not limitation, FIG. 3 shows features of a circuit 300 to access metadata which is to identify a source of data poisoning according to an embodiment. Circuit 300 may include features of one of circuit blocks 130a, 130b, . . . , 130n and/or may perform operations of method 200, for example. To facilitate efficient identification of a poison source, circuit block 300 comprises circuitry 302 to poison some data, wherein metadata—corresponding to said data—is accessed to provide an identifier of circuit block 300 as the poisoner of the data. Alternatively or in addition, circuit block 300 comprises circuitry 304 to determine that some received data has been previously poisoned, wherein—in some embodiments—circuitry 304 signals a fault which identifies some other circuit block (not shown) as the poisoner of the received data.

In the example embodiment shown, circuitry 302 comprises detector 310 which is coupled to receive an indication 305 of processing state at circuit block 300. Indication 305 includes any of various types of information which describes or otherwise indicates a state of processing by 300 and/or a state of other processing upon which such processing by 300 depends. Based on indication 305, detector 310 determines whether the processing state includes an error condition. Indication 305 includes, for example, data to be subjected to data error detection by detector 310, and/or information describing a timing, a result (or, alternatively, an absence of such a result) or other characteristic of a data processing operation. For example, indication 305 describes or otherwise indicates a data error, a buffer overflow, a process timeout, or the like. Some embodiments are not limited to a particular one or more error conditions to be tested for by detector 310, and/or are not limited to a particular basis—communicated with indication 305—upon which a given error condition is to be tested for.

Based on indication 305, detector 310 provides to tagger logic 320 of circuitry 302 a signal 312 identifying the detection of some error condition. Tagger logic 320 determines, based on the error condition indicated by signal 312, that some data 306 is to be poisoned—e.g., wherein tagger logic 320 determines that metadata corresponding to data 306 is to be generated, updated or otherwise accessed to indicate a poisoned state of data 306. As a result of such accessing, the metadata specifies that circuit block 300 (or at least some circuitry of circuit block 300) is the poisoner of data 306. In an embodiment, such specifying of circuit block 300 includes or is otherwise based on a unique identifier ID 322 of circuit block 300—e.g., where ID 322 is one of identifiers IDa, IDb of circuit blocks 130a, 130b. Such data poisoning includes, or results in, tagger logic 320 outputting a communication 324 which comprises data 306 and the metadata corresponding thereto—e.g., wherein communication 324 is sent from circuit block 300 (to another circuit block, for example) via an output interface 330 thereof.

Referring again to FIG. 2, method 200 alternatively or in addition comprises operations 202 performed at a second circuit block of the processor which performs at least some of method 200. Operations 202 comprise (at 220) receiving data and corresponding metadata which, for example, are communicated from the first circuit block at 212. In an embodiment, the data and metadata are communicated to the second circuit block automatically with each other—e.g., responsive to a request for the data and/or independent of an instruction of a software application (if any) which explicitly specifies a communication of the metadata.

Operations 202 further comprise (at 221) detecting the poisoned state of the data based on the metadata. The detecting at 221 comprises determining that the metadata includes a unique identifier assigned to the first circuit block. In such an embodiment, operations 202 further comprise (at 222) signaling a fault based on the determining performed at 221, where the signaling is with a message which—based on the metadata—identifies the first circuit block as the poisoner of the data.

For example, referring again to the example embodiment shown in FIG. 3, circuitry 304 comprises one or more circuits (such as the illustrative parser logic 305 shown) which receive a communication 342 of poisoned data and metadata corresponding thereto—e.g., wherein communication 342 is provided from another circuit block to an input interface 340 of circuit block 300. In the example embodiment shown, parser logic 350 identifies the metadata (illustrated as metadata 352) and provides it for analysis by metadata evaluation logic 360 of circuitry 304.

Such analysis includes, for example, metadata evaluation logic 360 detecting that metadata 352 indicates a poisoned state of the data which is provided in communication 342. The detecting includes, for example, metadata evaluation logic 360 determining that metadata 352 includes an identifier of another circuit block (which is coupled to circuit block 300) as a poisoner of the data. Based on such detecting, metadata evaluation logic 360—in some embodiments—generates a fault message 362 which comprises the identifier of the other circuit block. Fault message 362 is communicated from circuit block 300 via output interface 330, for example.

In some embodiments, the processor which performs method 200 (at least in part) further comprises a third circuit block which—after the communicating from the first circuit block 212, but before the communicating to the second circuit block at 220—receives, performs processing with, and outputs the data and corresponding metadata. The third circuit block comprises a memory resource such as memory 120, for example. In one such embodiment, any fault message generated by the third circuit block is independent of the first circuit block being identified by the metadata as the poisoner of the data. For example, the third circuit block, in one embodiment, detects a poisoned state of the data (based on the metadata) and further determines a process type of a process which is to be performed by the third circuit block based on the data. The process type may be one of multiple process types which are used by the third circuit block each as a possible basis for deciding to selectively generate, or prevent the generating of, a respective fault message in response to data being poisoned.

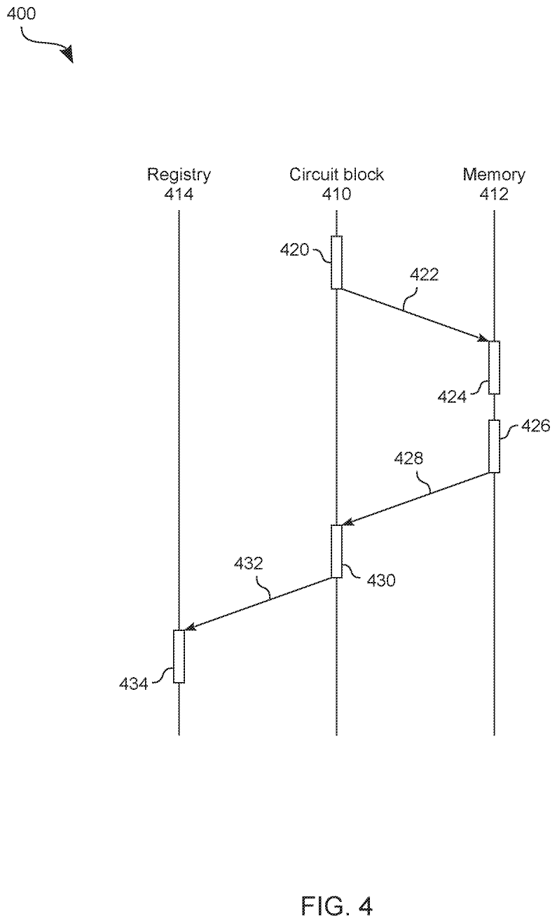

FIG. 4 shows features of a sequence 400 to communicate data poisoning information with circuitry of a processor according to an embodiment. Sequence 400 includes or is otherwise performed based on operations such as those of method 200—e.g., wherein some or all of sequence 400 is implemented with system 100 or circuit block 300. As shown in FIG. 4, sequence 400 includes various operations by, and communications among, circuit components including a circuit block 410, a memory 412 and a registry 414 which (for example) correspond functionally to circuit block 130a, memory 120 and repository 140, respectively. Registry 414 is available to receive and store fault message information generated by circuit block 410.

In the example embodiment shown, sequence 400 includes processing 420 by circuit block 410—e.g., where an execution unit of circuit block 410 executes an instruction of a software application. Based on processing 420, circuit block 410 sends to memory 412 a request 422 to read data from an addressable block of a memory array. Responsive to read request 422, memory 412 performs processing 424 to detect for an error (if any) of data targeted by read request 422. In the example scenario, processing 424 detect a data error condition, where (in response) memory 412 further performs processing 426 to poison the requested data.

The poisoning performed with processing 426 results in some metadata (which correspond to the targeted read data) specifying that memory 412 is a poisoner of said read data. Responsive to read request 422, the data is then provided, along the corresponding metadata, in a communication 428 from memory 412 to circuit block 410. With the metadata provided by communication 428, circuit block 410 performs processing 430 to detect for a poisoned state of the corresponding data. Based on processing 430, circuit block 410 generates a fault message 432 which, based on the metadata in communication 428, communicates the identifier of memory 412. Responsive to communication 432, registry 414 performs processing 434 to store fault information which, based on the metadata, identifies memory 412 as the poisoner of the data.

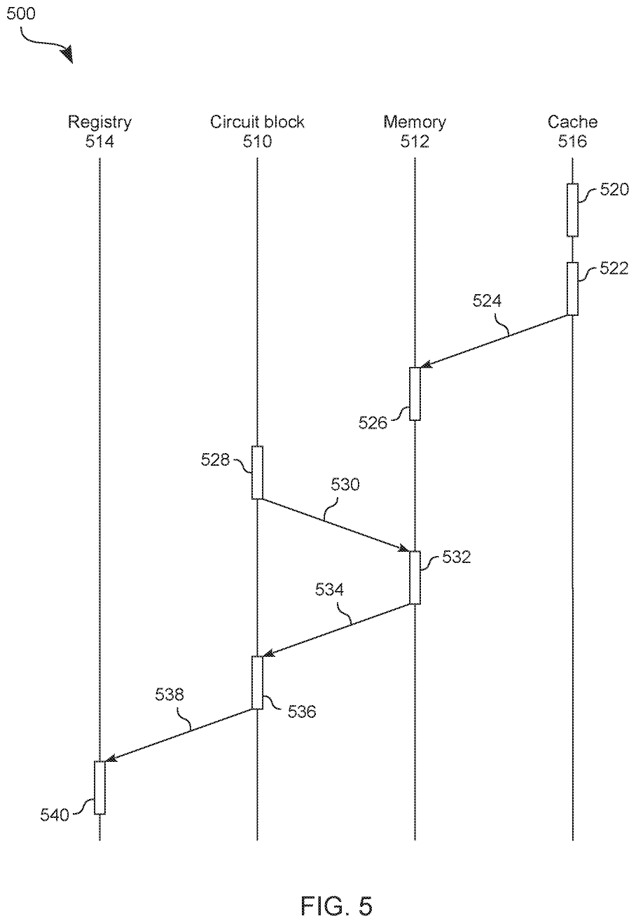

FIG. 5 shows features of a sequence 500 to communicate data poisoning information with circuitry of a processor according to another embodiment. Sequence 500 includes or is otherwise performed based on operations such as those of method 200—e.g., wherein some or all of sequence 500 is implemented with system 100 or circuit block 300. As shown in FIG. 5, sequence 500 includes various operations by, and communications among, circuit components including a circuit block 510, a memory 512, a registry 514 and a cache 516. Registry 514 is available to receive and store fault message information generated by circuit block 510.

In the example embodiment shown, sequence 500 includes processing 520 by cache 516 (e.g., a last level cache) to detect for an error, if any, of data which is to be flushed to memory 512. In an example scenario, processing 520 detect a data error condition, where (in response) cache 516 further performs processing 522 to poison the requested data. The poisoning performed with processing 522 results in metadata which specifies that cache 516 is a poisoner of the data, which is provided—along with the metadata—in a communication 524 to memory 512 for storage therein.

Subsequently, processing 528 is performed by circuit block 510, resulting in circuit block 510 sending to memory 512 a data read request 530. Responsive to read request 530, memory 512 performs processing 532 to retrieve, from a targeted memory block, the data and corresponding metadata which was previously provided to memory 512 via communication 524.

Responsive to read request 530, the data is then provided, along with the corresponding metadata, in a communication 534 from memory 512 to circuit block 510. With the metadata provided by communication 534, circuit block 510 performs processing 536 to detect for a poisoned state of the corresponding data. Based on processing 536, circuit block 510 generates a fault message 538 which, based on the metadata in communication 534, communicates the identifier of cache 516. Responsive to communication 538, registry 514 performs processing 540 to store fault information which, based on the metadata, identifies cache 516 as the poisoner of the data.

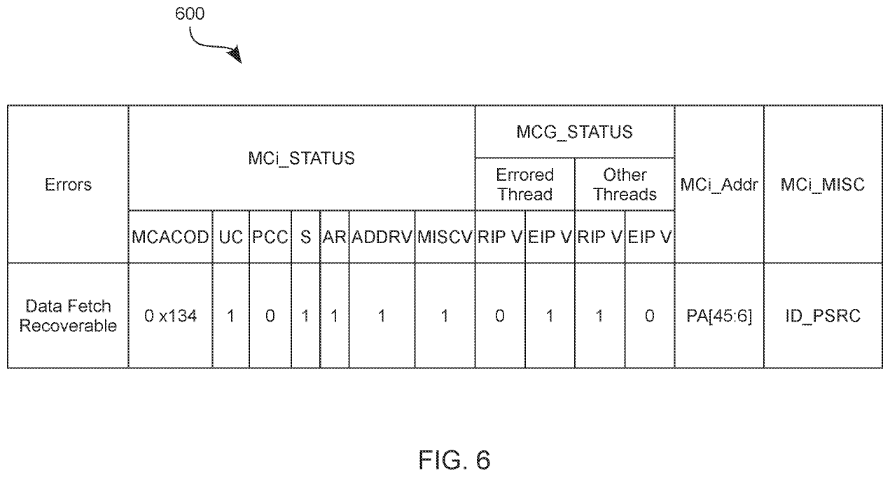

FIG. 6 shows features of an error log 600 to provide information identifying a source of data poisoning according to an embodiment. Error log 600 includes or is otherwise based on information which is communicated by method 200, sequence 400 or sequence 500, for example. In an embodiment, error log 600 is provided with one or more registers of repository 140 (or other such resources of a processor).

In the exemplary error log 600 shown in FIG. 6, a recoverable error is indicated if the processor context is not corrupt as indicated by MCi_STATUS.PCC=0, the system address is available as indicated by MCi_STATUS.ADDRV=1 and MCi_MISC[8:6]=′010. In one embodiment, the MCACOD field and MCG_STATUS fields are different to distinguish between the instruction fetch vs. the data fetch error logs. The following fields have the following meanings in one embodiment of the error log:

In MCi_STATUS: MCACOD is an architecturally specified error code field that describes the type of error encountered. UC represents an Uncorrected field. When ‘1 the error was of an uncorrected type. When ‘0 the error was of a corrected type. PCC represents a Processor Context Corrupt field. When set it means the processor context was corrupt. When clear it means it was not. S represents a Signaling field. When set the error logged was signaled via a machine check exception. When clear it was signaled via a CMCI. AR represents an Action Required field. When set, SW must take immediate action. When clear SW may delay the action until a later time. ADDRV—Address Valid. When set it indicates that a valid address was logged in MCi_ADDR MSR. When clear it indicates no valid address exists. MISCV represents a MCi_MISC Valid field. When set it indicates that there is valid content in the MCi_MISC MSR. When clear it indicates that there is no valid content in MCi_MISC.

In MCG_STATUS: RIPV represents a Restart IP Valid field. When set it indicates that program execution can be restarted reliably at the instruction pointed to by the instruction pointer pushed on the stack by the machine check exception handler call. When clear, the program cannot be reliably restarted at the pushed instruction pointer. EIPV represents an Error IP Valid field. Indicates (when set) that the instruction pointed to by the instruction pointer pushed onto the stack when the machine check exception is generated is directly associated with the error. When this flag is cleared, the instruction pointed to may not be associated with the error. MCi_ADDR—contains the address associated with the error. MCi_MISC contains an identifier ID_PSRC of a poisoner of data associated with the error—e.g., wherein a communication of ID_PSRC is performed in, association with a communication of the data, to a circuit block which issued a fault message to generate error log 600.

The figures described herein detail exemplary architectures and systems to implement embodiments of the above. In some embodiments, one or more hardware components and/or instructions described herein are emulated as detailed below, or implemented as software modules.

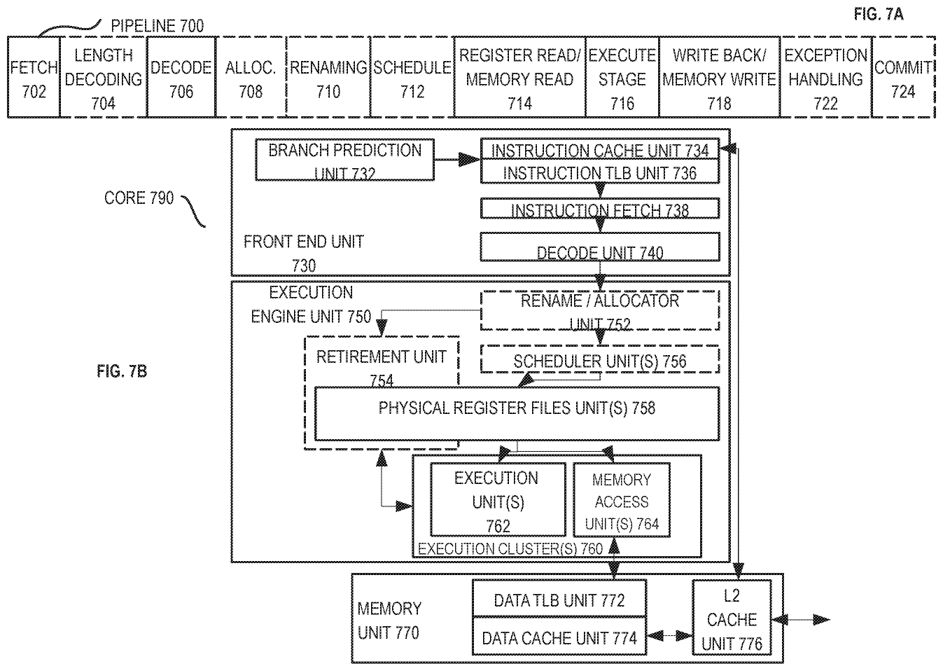

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front-end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front-end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

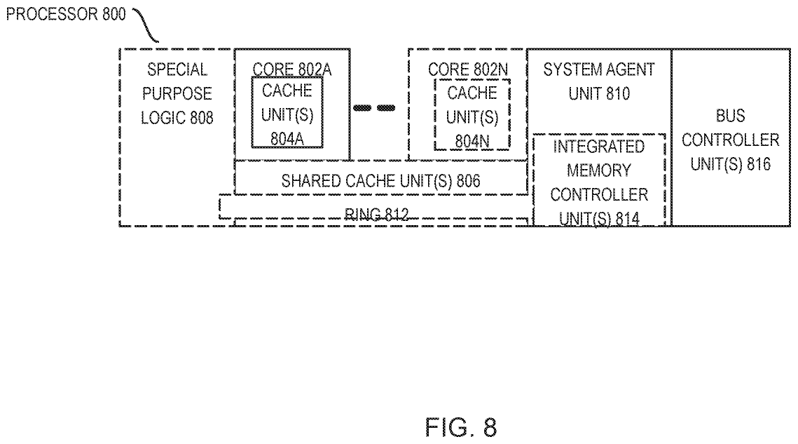

FIG. 8 is a block diagram of a processor 800 that may have more than one core, may have an integrated memory controller, and may have integrated graphics according to embodiments of the invention. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) 814 in the system agent unit 810, and special purpose logic 808.

Thus, different implementations of the processor 800 may include: 1) a CPU with the special purpose logic 808 being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache within the cores (e.g., including cache units 804A-N), a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof. While in one embodiment a ring-based interconnect unit 812 interconnects the integrated graphics logic 808, the set of shared cache units 806, and the system agent unit 810/integrated memory controller unit(s) 814, alternative embodiments may use any number of well-known techniques for interconnecting such units. In one embodiment, coherency is maintained between one or more cache units 806 and cores 802A-N.

In some embodiments, one or more of the cores 802A-N are capable of multithreading. The system agent 810 includes those components coordinating and operating cores 802A-N. The system agent unit 810 may include for example a power control unit (PCU) and a display unit. The PCU may be or include logic and components needed for regulating the power state of the cores 802A-N and the integrated graphics logic 808. The display unit is for driving one or more externally connected displays.

The cores 802A-N may be homogenous or heterogeneous in terms of architecture instruction set; that is, two or more of the cores 802A-N may be capable of execution the same instruction set, while others may be capable of executing only a subset of that instruction set or a different instruction set.

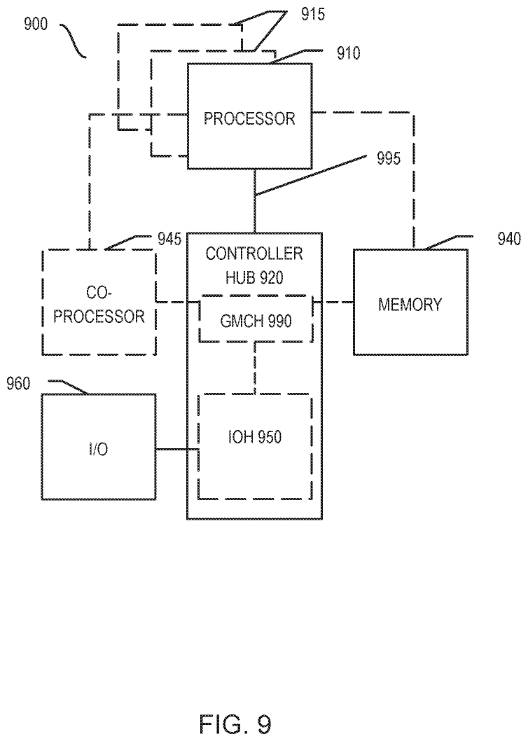

FIGS. 9-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a system 900 in accordance with one embodiment of the present invention. The system 900 may include one or more processors 910, 915, which are coupled to a controller hub 920. In one embodiment the controller hub 920 includes a graphics memory controller hub (GMCH) 990 and an Input/Output Hub (IOH) 950 (which may be on separate chips); the GMCH 990 includes memory and graphics controllers to which are coupled memory 940 and a coprocessor 945; the IOH 950 is couples input/output (I/O) devices 960 to the GMCH 990. Alternatively, one or both of the memory and graphics controllers are integrated within the processor (as described herein), the memory 940 and the coprocessor 945 are coupled directly to the processor 910, and the controller hub 920 in a single chip with the IOH 950.

The optional nature of additional processors 915 is denoted in FIG. 9 with broken lines. Each processor 910, 915 may include one or more of the processing cores described herein and may be some version of the processor 800.

The memory 940 may be, for example, dynamic random access memory (DRAM), phase change memory (PCM), or a combination of the two. For at least one embodiment, the controller hub 920 communicates with the processor(s) 910, 915 via a multi-drop bus, such as a frontside bus (FSB), point-to-point interface such as QuickPath Interconnect (QPI), or similar connection 995.

In one embodiment, the coprocessor 945 is a special-purpose processor, such as, for example, a high-throughput MIC processor, a network or communication processor, compression engine, graphics processor, GPGPU, embedded processor, or the like. In one embodiment, controller hub 920 may include an integrated graphics accelerator.

There can be a variety of differences between the physical resources 910, 915 in terms of a spectrum of metrics of merit including architectural, microarchitectural, thermal, power consumption characteristics, and the like.

In one embodiment, the processor 910 executes instructions that control data processing operations of a general type. Embedded within the instructions may be coprocessor instructions. The processor 910 recognizes these coprocessor instructions as being of a type that should be executed by the attached coprocessor 945. Accordingly, the processor 910 issues these coprocessor instructions (or control signals representing coprocessor instructions) on a coprocessor bus or other interconnect, to coprocessor 945. Coprocessor(s) 945 accept and execute the received coprocessor instructions.

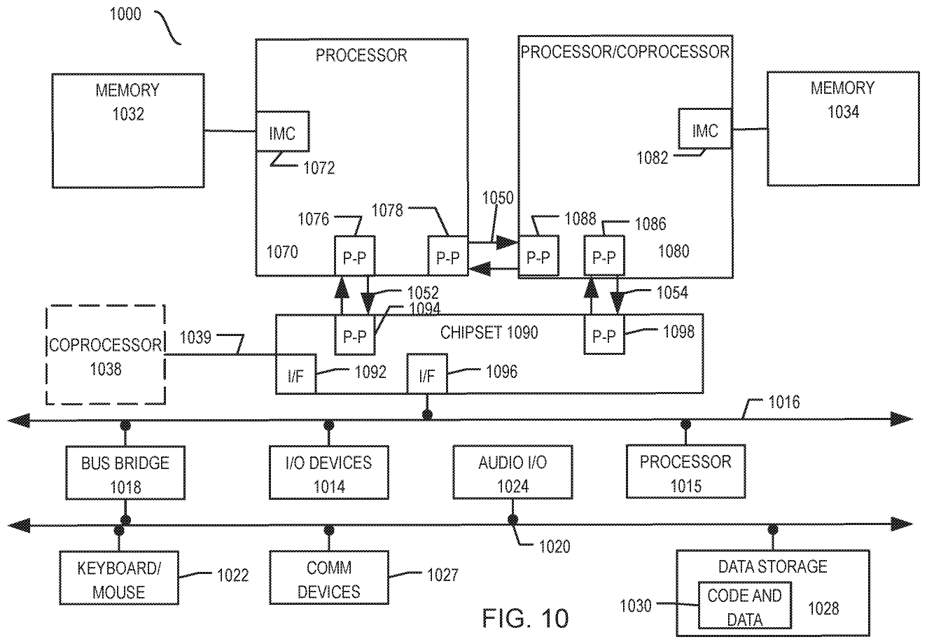

Referring now to FIG. 10, shown is a block diagram of a first more specific exemplary system 1000 in accordance with an embodiment of the present invention. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 800. In one embodiment of the invention, processors 1070 and 1080 are respectively processors 910 and 915, while coprocessor 1038 is coprocessor 945. In another embodiment, processors 1070 and 1080 are respectively processor 910 coprocessor 945.

Processors 1070 and 1080 are shown including integrated memory controller (IMC) units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1092 and an interconnect 1039. In one embodiment, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 may be coupled to first bus 1016, along with a bus bridge 1018 which couples first bus 1016 to a second bus 1020. In one embodiment, one or more additional processor(s) 1015, such as coprocessors, high-throughput MIC processors, GPGPU's, accelerators (such as, e.g., graphics accelerators or digital signal processing (DSP) units), field programmable gate arrays, or any other processor, are coupled to first bus 1016. In one embodiment, second bus 1020 may be a low pin count (LPC) bus. Various devices may be coupled to a second bus 1020 including, for example, a keyboard and/or mouse 1022, communication devices 1027 and a storage unit 1028 such as a disk drive or other mass storage device which may include instructions/code and data 1030, in one embodiment. Further, an audio I/O 1024 may be coupled to the second bus 1020. Note that other architectures are possible. For example, instead of the point-to-point architecture of FIG. 10, a system may implement a multi-drop bus or other such architecture.

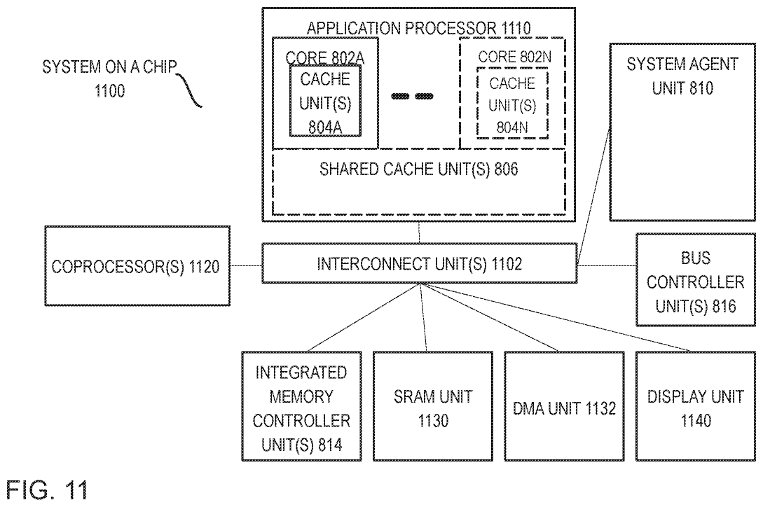

Referring now to FIG. 11, shown is a block diagram of a SoC 1100 in accordance with an embodiment of the present invention. Similar elements in FIG. 8 bear like reference numerals. Also, dashed lined boxes are optional features on more advanced SoCs. In FIG. 11, an interconnect unit(s) 1102 is coupled to: an application processor 1110 which includes a set of one or more cores 202A-N and shared cache unit(s) 806; a system agent unit 810; a bus controller unit(s) 816; an integrated memory controller unit(s) 814; a set or one or more coprocessors 1120 which may include integrated graphics logic, an image processor, an audio processor, and a video processor; an static random access memory (SRAM) unit 1130; a direct memory access (DMA) unit 1132; and a display unit 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products. Techniques and architectures for performing an in-memory computation are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
a first circuit block to receive, based on an instruction of an application, data and metadata which corresponds to the data, wherein the metadata is to be communicated to the first circuit block, in association with a communication of the data to the first circuit block, wherein the metadata is to indicate a poisoned state of the data, wherein, based on a unique identifier assigned to a second circuit block, the metadata is to identify the second circuit block as a poisoner of the data, wherein the first circuit block comprises:
first circuitry to detect the poisoned state of the data based on the metadata, comprising the first circuitry to determine that the metadata includes the unique identifier assigned to the second circuit block; and
second circuitry, responsive to the first circuitry, to signal a fault with a message which identifies the second circuit block as the poisoner of the data.

2. The processor of claim 1, wherein the second circuit block is coupled to the processor.

3. The processor of claim 1, wherein the processor comprises the second circuit block, wherein the second circuit block comprises:
third circuitry to detect an error condition at the second circuit block;
fourth circuitry to access the metadata, responsive to the third circuitry, to indicate the poisoned state of the data and, based on the unique identifier, to identify the second circuit block as the poisoner of the data; and
fifth circuitry to communicate the data from the second circuit block in association with a communication of the metadata from the second circuit block.

4. The processor of claim 3, wherein the processor further comprises a third circuit block comprising:
sixth circuitry to receive the data and the metadata after the data and the metadata are communicated from the second circuit block, wherein any fault message generated by the third circuit block is independent of an identification by the metadata of the second circuit block as the poisoner of the data; and
seventh circuitry to communicate the data and the metadata from the third circuit block prior to the first circuit block receiving the data and the metadata.

5. The processor of claim 4, wherein the sixth circuitry is to:
detect the poisoned state of the data based on the data;
detect a process type of a process to be performed by the third circuit block based on the data; and
based on the process type:
prevent a generation of a fault message based on the poisoned state of the data; and
permit a performance of the process.

6. The processor of claim 4, wherein the third circuit block comprises a memory.

7. The processor of claim 1, wherein the first circuit block further comprises:
third circuitry to detect a second error condition at the first circuit block;
fourth circuitry to access second metadata, responsive to the third circuitry, to indicate a poisoned state of second data and, based on a second unique identifier assigned to the first circuit block, to identify the first circuit block as a second poisoner of the second data; and
fifth circuitry to communicate the second data from the first circuit block in association with a communication of the second metadata from the first circuit block.

8. The processor of claim 1, wherein a format of the metadata comprises a flag field comprising one or more bits which specify whether the data is poisoned.

9. The processor of claim 1, wherein a format of the metadata comprises a poison source field to store an identifier of a data poisoner, wherein a storage of a default value at the poison source field indicates a non-poisoned data state.

10. A method at a processor, the method comprising:
based on an instruction of an application, receiving, at a first circuit block of the processor, data and metadata corresponding to the data, wherein the metadata is communicated to the first circuit block, in association with a communication of the data to the first circuit block, wherein the metadata indicates a poisoned state of the data, wherein, based on a unique identifier assigned to a second circuit block, the metadata identifies the second circuit block as a poisoner of the data;
with the first circuit block:
detecting the poisoned state of the data based on the metadata, comprising determining that the metadata includes the unique identifier assigned to the second circuit block; and
based on the determining, signaling a fault with a message which identifies the second circuit block as the poisoner of the data.

11. The method of claim 10, wherein the processor comprises the second circuit block, the method further comprising:
at the second circuit block:
detecting an error condition at the second circuit block;
based on the detecting of the error condition, accessing the metadata to indicate the poisoned state of the data and, based on the unique identifier, to identify the second circuit block as the poisoner of the data; and
communicating the data from the second circuit block in association with a communication of the metadata from the second circuit block.

12. The method of claim 11, wherein the processor further comprises a third circuit block, the method further comprising:
at the third circuit:
receiving the data and the metadata after the data and the metadata are communicated from the second circuit block, wherein any fault message generated by the third circuit block is independent of an identification by the metadata of the second circuit block as the poisoner of the data; and
communicating the data and the metadata from the third circuit block prior to the first circuit block receiving the data and the metadata.

13. The method of claim 12, further comprising:
at the third circuit block:
detecting the poisoned state of the data based on the data;
detecting a process type of a process to be performed by the third circuit block based on the data; and
based on the process type:
preventing a generation of a fault message based on the poisoned state of the data; and
permitting a performance of the process.

14. The method of claim 12, wherein the third circuit block comprises a memory.

15. The method of claim 10, wherein a format of the metadata comprises a flag field comprising one or more bits which specify whether the data is poisoned.

16. A system comprising
a processor comprising:
a first circuit block to receive, based on an instruction of an application, data and metadata which corresponds to the data, wherein the metadata is to be communicated to the first circuit block, in association with a communication of the data to the first circuit block, wherein the metadata is to indicate a poisoned state of the data, wherein, based on a unique identifier assigned to a second circuit block, the metadata is to identify the second circuit block as a poisoner of the data, wherein the first circuit block comprises:
first circuitry to detect the poisoned state of the data based on the metadata, comprising the first circuitry to determine that the metadata includes the unique identifier assigned to the second circuit block; and
second circuitry, responsive to the first circuitry, to signal a fault with a message which identifies the second circuit block as the poisoner of the data; and
a display device coupled to the processor, the display device to display an image based on the data.

17. The system of claim 16, wherein the second circuit block is coupled to the processor.

18. The system of claim 16, wherein the processor comprises the second circuit block, wherein the second circuit block comprises:
third circuitry to detect an error condition at the second circuit block;
fourth circuitry to access the metadata, responsive to the third circuitry, to indicate the poisoned state of the data and, based on the unique identifier, to identify the second circuit block as the poisoner of the data; and
fifth circuitry to communicate the data from the second circuit block in association with a communication of the metadata from the second circuit block.

19. The system of claim 18, further comprising a third circuit block coupled to the processor, the third circuit block comprising:
sixth circuitry to receive the data and the metadata after the data and the metadata are communicated from the second circuit block, wherein any fault message generated by the third circuit block is independent of an identification by the metadata of the second circuit block as the poisoner of the data; and
seventh circuitry to communicate the data and the metadata from the third circuit block prior to the first circuit block receiving the data and the metadata.

20. The system of claim 16, wherein the first circuit block further comprises:
third circuitry to detect a second error condition at the first circuit block;
fourth circuitry to access second metadata, responsive to the third circuitry, to indicate a poisoned state of second data and, based on a second unique identifier assigned to the first circuit block, to identify the first circuit block as a second poisoner of the second data; and
fifth circuitry to communicate the second data from the first circuit block in association with a communication of the second metadata from the first circuit block.

21. The system of claim 16, wherein a format of the metadata comprises a poison source field to store an identifier of a data poisoner, wherein a storage of a default value at the poison source field indicates a non-poisoned data state.
